(19) United States
(12) Patent Application Publication
(10) Pub. No.: US 2020/0383761 A1
(43) Pub. Date: Dec. 10, 2020

(54) ORAL CLEANING DEVICE WITH VARIABLE FLUID PRESSURIZATION

(71) Applicant: KONINKLIJKE PHILIPS N.V., Eindhoven (NL)

(72) Inventors: Joldert Maria BOERSMA, Zuidhorn (NL); Klaas KOOIJKER, Drachten (NL)

(21) Appl. No.: 16/767,143

(22) PCT Filed: Nov. 28, 2018
(86) PCT No.: PCT/EP2018/082775

§ 371 Date: May 27, 2020

Related U.S. Application Data
(60) Provisional application No. 62/591,386, filed on Nov. 28, 2017.

(51) Int. Cl. A61C 17/028; F04B 53/14; A61C 17/02

(52) U.S. Cl. CPC A61C 17/028; A61C 17/0202; F04B 53/14

(57) ABSTRACT

A pump assembly (22) including a piston (36) reciprocal within a cylinder (48) for pressurizing a fluid in a pressure chamber (38) of the cylinder. A biasing member is configured to exert a driving force on the piston to drive the piston in a pumping direction from a reset position to a deployed position. A drivetrain (34) is engageable with the piston and provides power sufficient to transition the piston back to the reset position. A stroke limiting mechanism (42) has a stopping member (82) with a stopping surface (86) against which a protrusion (92) of the piston contacts to define a stroke length of the piston by limiting movement of the piston in the pumping direction (94) when the protrusion engages the stopping surface. The stopping member has a first configuration corresponding to a first stroke length for the piston and a second configuration corresponding to a second stroke length.

### FIELD OF THE INVENTION

The present disclosure is directed generally to oral care appliances for cleaning teeth, and particularly to pump assemblies providing adjustable or variable fluid pressurization.

### BACKGROUND

Proper tooth brushing, including length and coverage of brushing, helps promote long-term dental health. Many dental problems are experienced by individuals who either do not regularly brush their teeth or who do so inadequately, especially in a particular area or region of the oral cavity. Among individuals who do brush regularly, improper brushing habits can result in poor coverage of brushing and thus surfaces that are not adequately cleaned during a cleaning session, even when a standard brushing regimen, such as brushing for two minutes twice daily, is followed.

One facet of proper tooth brushing is the use of oral irrigators to remove dental plaque to clean gums and teeth. Oral irrigators are especially important in areas where toothbrushes cannot easily access, such as between the teeth and at the gum margin. Some oral irrigators use a constant water jet, while others use a combination of water and air. However, these devices do not allow a user, such as an individual suffering from sensitive gums (e.g., caused by gingivitis), to adjust the flow or pressure of the fluid (e.g., water and/or air).

Accordingly, there is a continued need in the art for personal oral care devices that enable users a greater degree of control over performance of aspects of the device, such as fluid pressure control.

### SUMMARY OF THE INVENTION

The present disclosure is directed to inventive pump assemblies with adjustable or variable fluid pressurization. Various embodiments and implementations herein are directed to pump assemblies having an adjustable stroke length to variably set the fluid pressurization. The pump assembly may be included by an oral care device, such as an electronic flossing device that provides a jet or stream of pressurized fluid to clean the interdental spaces between teeth. The pump assembly includes a stroke limiting mechanism that has a stopping surface that is engageable by a protrusion of a piston of the pump. Movement of the piston in a pumping direction of the piston is limited when the protrusion engages against the stopping surface. The stroke limiting mechanism can be manipulated to change a location of the stopping surface with respect to the pumping direction of the piston in order to change the location at which the protrusion engages the stopping surface. Longer stroke lengths are achieved by changing the location of the stopping surface further along in the pumping direction and shorter stroke lengths are achieved by moving the location of the stopping surface in the opposite direction.

Generally, in one aspect, a pump assembly is provided. The pump assembly includes a piston configured to reciprocate between a reset position and a deployed position to pressurize a fluid in a pressure chamber; a biasing member configured to exert a driving force on the piston to drive the piston in a pumping direction from the reset position to the deployed position; a drivetrain engageable with the piston and providing power sufficient to overcome the driving force of the biasing member and transitioning the piston from the deployed position back to the reset position; a stroke limiting mechanism having a stopping member with a stopping surface against which a protrusion of the piston contacts to define a stroke length of the piston by limiting movement of the piston in the pumping direction when the protrusion engages the stopping surface; wherein the stopping member has a first configuration corresponding to a first stroke length for the piston and a second configuration corresponding to a second stroke length for the piston, the first stroke length corresponding to a first pressurization of the fluid and the second stroke length corresponding to a second pressurization of the fluid that is different than the first pressurization, wherein transitioning the stopping member between the first and second configurations positions the stopping surface at different locations relative to the deployed position with respect to the pumping direction.

In an embodiment, the pump assembly includes a motor, wherein the power provided by the drivetrain to the piston is generated by the motor. In an embodiment, the drivetrain is semi-free in that the drivetrain is both engaged and disengaged from the piston at different times during reciprocation of the piston.

In an embodiment, the drivetrain includes a drive member having a pin eccentrically mounted thereto and extending therefrom, wherein rotation of the drive member brings the pin into engagement with a hook extending from the piston and power from the drivetrain is transferred to the piston via engagement of the pin and the hook. In a further embodiment, further rotation of the drive member causes the pin to disengage from the hook to decouple the piston from the drivetrain and the biasing member exerts the drive force when the piston is decoupled from the drivetrain.

In an embodiment, the stopping member includes a disc eccentrically mounted with respect to the piston. In a further embodiment, the stopping surface is a circumferential surface of the disc, and eccentric rotation of the disc changes a location of the stopping surface, relative to the pumping direction, that is aligned to engage the protrusion of the piston.

In an embodiment, the stopping member has a plurality of the stopping surfaces, each of the stopping surfaces in the plurality corresponding to a different dimension to change a location of the stopping surface, relative to the pumping direction, that is aligned to engage the protrusion of the piston. In an embodiment, the stopping surface is positioned closer to the deployed position, with respect to the pumping direction, when the stopping member is in the first configuration than when the stopping member is in the second configuration, which results in the first stroke length being longer than the second stroke length and the first pressurization being greater than the second pressurization.

According to one aspect, an oral care device is provided that includes a pump assembly according to any of the embodiments disclosed herein. In an embodiment, the oral care device includes a fluid pathway in fluid communication with the pressure chamber, the fluid pathway terminating in a port of a nozzle head of the oral care device, wherein the fluid is emitting out of the device via the port.

In an embodiment, the oral care device includes a user input in communication with the stroke limiting mechanism of the pump assembly. In a further embodiment, the user input is mechanically coupled to the stroke limiting mechanism. In an embodiment, the user input device includes a knob, slider, lever, button, or dial that is configured to translate user inputted manipulation to a corresponding motion of the stopping member of the stroke limiting mechanism. In an embodiment, the oral care device further includes a controller that is arranged in signal communication with both the stroke limiting mechanism and the user input and configured to implement commands inputted via the user input to the stroke limiting mechanism.

As used herein for purposes of the present disclosure, the term “controller” is used generally to describe various software and hardware apparatus relating to the operation of an apparatus, system, or method. A controller can be implemented in numerous ways (e.g., such as with dedicated hardware) to perform various functions discussed herein. A “processor” is one example of a controller, or controller component, which may be programmed using software (including executable code and/or machine language instructions) to perform various functions discussed herein. A controller may be implemented with or without employing a processor, and also may be implemented as a combination of dedicated hardware to perform some functions and a processor (e.g., one or more programmed microprocessors and associated circuitry) to perform other functions. Examples of controller components that may be employed in various embodiments of the present disclosure include, but are not limited to, conventional microprocessors, application specific integrated circuits, and field-programmable gate arrays.

The term “user interface” as used herein refers to an interface between a human user or operator and one or more devices that enables communication between the user and the device(s). Examples of user interfaces that may be employed in various implementations of the present disclosure include, but are not limited to, switches, potentiometers, buttons, knobs, dials, sliders, track balls, display screens, various types of graphical user interfaces (GUIs), touch screens, microphones and other types of sensors that may receive some form of human-generated stimulus and generate a signal in response thereto.

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein. It should also be appreciated that terminology explicitly employed herein that also may appear in any disclosure incorporated by reference should be accorded a meaning most consistent with the particular concepts disclosed herein.

### BRIEF DESCRIPTION OF THE DRAWINGS

In the drawings, like reference characters generally refer to the same parts throughout the different views. Also, the drawings are not necessarily to scale, emphasis instead generally being placed upon illustrating the principles of the invention.

FIG. 1 is a schematic view of an oral care device having a stroke limiting mechanism according to one embodiment disclosed herein.

FIGS. 2A and 2B are schematic views of a pump assembly having a piston in a deployed position and a reset position, respectively.

FIG. 3 is a perspective view of a pump assembly having a semi-free drivetrain according to one embodiment disclosed herein where a pin of the drivetrain is engaged against a hook of a piston of the pump assembly.

FIG. 4 is a perspective view of the pump assembly of FIG. 3 where the pin is disengaging from the hook to release the piston.

FIG. 5 is a perspective view of the pump assembly of FIG. 3 where the piston is in an intermediate position between its deployed position and its reset position.

FIG. 6 is a perspective view of the pump assembly of FIG. 5 where the pin is entering engagement with the hook of the piston.

FIG. 7 is a perspective view of a pump assembly having a stroke limiting mechanism according to one embodiment disclosed herein with a stopping member of the stroke limiting mechanism in a first position.

FIG. 8 is a perspective view of the pump assembly the pump assembly of FIG. 7 with the stopping member of the stroke limiting mechanism in a second position.

FIG. 9 is a schematic view of a stopping member according to one embodiment disclosed herein.

FIG. 10 is a schematic cross-sectional view of a stopping member of a stroke limiting mechanism mechanically coupled to a user input.

### DETAILED DESCRIPTION OF EMBODIMENTS

The present disclosure describes various embodiments of oral care devices that have an adjustable or variable fluid pressurization of a stream or jet of fluid emitted from the oral care device. More generally, Applicant has recognized and appreciated that it would be beneficial to provide a pump assembly having an adjustable stroke length for adjusting the fluid pressurization achieved by the pump assembly. The pump assembly includes a stroke limiting mechanism that has a stopping surface that is engageable by a protrusion of a piston of the pump. Movement of the piston in a pumping direction of the piston is limited when the protrusion engages against the stopping surface. The stroke limiting mechanism can be manipulated to change a location of the stopping surface with respect to the pumping direction of the piston in order to change the location at which the protrusion engages the stopping surface. Longer stroke lengths are achieved by changing the location of the stopping surface further along in the pumping direction and shorter stroke lengths are achieved by moving the location of the stopping surface in the opposite direction.

The embodiments and implementations disclosed or otherwise envisioned herein can be utilized with any oral care device that emits a jet or stream of fluid during use, including but not limited to a toothbrush, a flossing device, an oral irrigator, or any other oral care device. For example, one application of the embodiments and implementations herein is to enable a user to change the fluid pressure of the fluid discharged from the device. However, the disclosure is not limited to oral care devices and thus the disclosure and embodiments disclosed herein can encompass any other device.

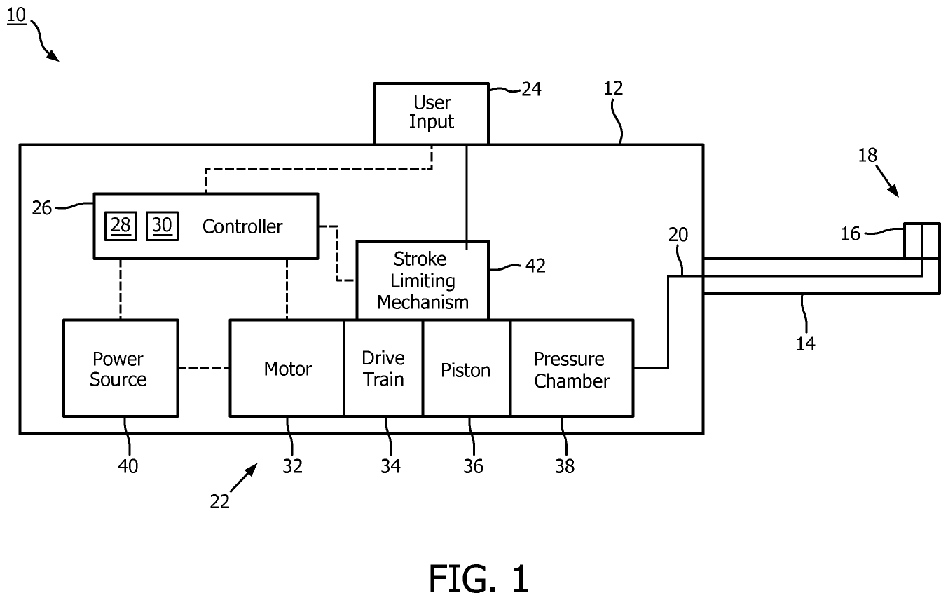

Referring to FIG. 1, in one embodiment, is an oral care device 10 with a body portion 12 and a nozzle member 14 mounted on the body portion 12. The nozzle member 14 includes at its end remote from the body portion 12 a nozzle head 16 with a port 18 configured to discharge fluid (e.g., water and/or air) from the device 10. According to an embodiment, the body portion 12, the nozzle member 14, the nozzle head 16, etc., are configured with a fluid pathway 20 arranged as a tube, channel, conduit, etc., to enable the passage of pressurized fluid from a pump assembly 22 located in the body 12, where the fluid is pressurized, to the nozzle head 16, where it is discharged out of the port 18. The nozzle member 14 may be detachably mounted onto body portion 12 such that the nozzle member 14 can periodically be replaced with a new one when a component of the device is worn out or otherwise requires replacement.

The body portion 12 is further provided with a user input 24. The user input 24 allows a user to operate and/or control various functionality of the oral care device 10. For example, the user input 24 may be used by a user to turn the oral care device 10 on and off, to enable functionality of the device 10, to switch between modes of operation of the user input 24, etc. The user input 24 may, for example, be, or include, one or more buttons, touch screens, switches, levers, toggles, knobs, etc. The user input 24 may be any combination of electronic (e.g., configured to send electrical signals) or mechanical (e.g., includes one or linkages, components, or devices that are physically actuated by a user's manipulation of the user input 24).

In one embodiment, the device 10 includes a controller 26 in signal communication with the user input 24. That is, the controller 26 may be formed of one or more circuits, modules, or other electronic or computer modules, and is configured to operate the oral care device 10, e.g., in response to an input, such as input obtained via user input 24. The controller 26 may comprise, for example, at least a processor 28 and a memory 30. The processor 28 may take any suitable form, including but not limited to a microcontroller, multiple microcontrollers, circuitry, plural processors, etc. The memory 30 can take any suitable form, including a non-volatile memory and/or RAM. The non-volatile memory may include read only memory (ROM), a hard disk drive (HDD), or a solid state drive (SSD). The memory 30 can store, among other things, an operating system, program, code, application, instructions, or other software for controlling operation of the device 10. The controller 26 can be used to instruct the components of the device 10 how to operate, cause implementation of the commands inputted via the user input 24, etc.

The pump assembly 22 of the device 10 includes a motor 32 for providing mechanical power via a drivetrain 34 to operate a piston 36. Operation of the piston 36 pressurizes fluid in a pressure chamber 38 in fluid communication with the piston 36, which pressurized fluid is communicated to the port 18 via the fluid pathway 20. The motor 32 may derive energy from a power source 40, e.g., a battery internal to the body 12 or an electrical interface that receives energy from an external source such as an electrical wall outlet.

A stroke limiting mechanism 42 is also included in pump assembly 22 coupled to the user input 24 and the drivetrain 34 and/or the piston 36 and configured to change a stroke length of the piston 36. By “coupled to”, it is meant that one or more components of the stroke limiting mechanism 42 are mechanically connected to components of the drivetrain 34 and/or the piston 36, and/or integrally formed with, by, or from components of the drivetrain 34 and/or the piston 36. As will be better appreciated in view of the below disclosure, the stroke limiting mechanism 42 includes stopping surface against which a corresponding portion of the piston 36 will engage during each reciprocal cycle of the piston 36 to limit the movement of the piston 36. By changing the location of the stopping surface relative to the piston 36, the stroke length of the piston 36 can be altered.

The stroke limiting mechanism 42 is also in communication with the user input 24. In one embodiment, the communication is mechanical in that the stroke limiting mechanism 42 and the user input 24 have components that are mechanically coupled to each other, and that physical manipulation of the user input 24 (e.g., turning a knob, moving a slider, flipping a lever, pressing a button, etc.) results in the physical manipulation of the user input 24 actuating the stroke limiting mechanism 42 to change the stroke length of the piston 36. In one embodiment, manipulation of the user input 24 results in generation of a signal that is communicated to the controller 26, which electrically communicates with the stroke limiting mechanism 42 to change the stroke length of the piston 36, e.g., via a servo, actuator, etc. included by the stroke limiting mechanism 42.

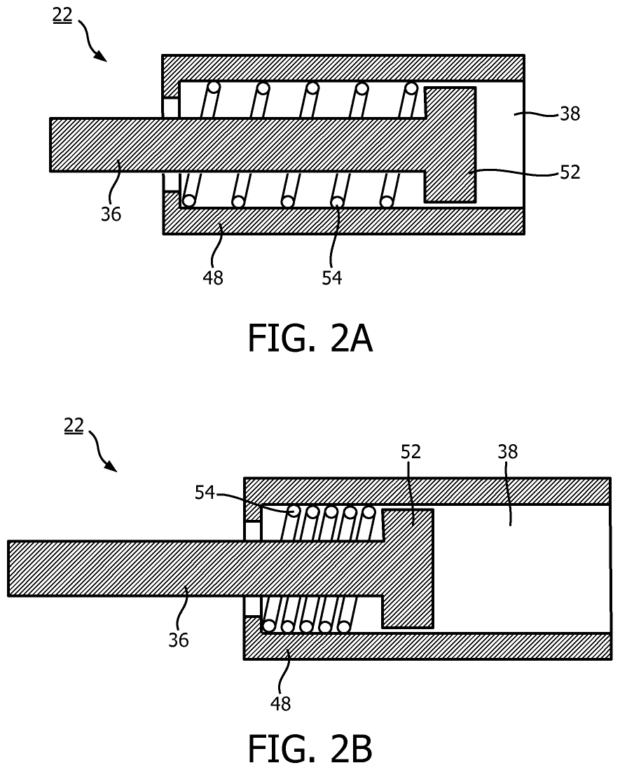

FIGS. 2A and 2B illustrate a pump assembly 22 according to one embodiment. More specifically, a piston 36 is located within a cylinder 48, with the piston 36 illustrated in a deployed or forward position in FIG. 2A and a reset position in FIG. 2B. The difference between the deployed position of FIG. 2A and the reset position of FIG. 2B defines the stroke length of the piston 36. The cylinder 48 defines a pressure chamber 38 on one side of a piston head 52 of the piston 36. Reciprocal motion of the piston 36 in the cylinder 48 causes pressurization of fluid within the pressure chamber 38 (e.g., which could be communicated through the fluid pathway 20 of the device 10). More specifically, a spring 54 or other biasing member may be included to exert a driving force on the piston 36 via engagement against the piston head 52 to drive the piston 36 forward to the position shown in FIG. 2A, thereby compressing and pressurizing fluid in the pressure chamber 38. The piston head 52 may be dynamically sealed with respect to the walls of the cylinder 48 to prevent fluid from leaking past the piston head 52 and thereby improving the pressurization achieved in the pressure chamber 38. A motor 32 or other mechanism may be included to reset the reciprocal action of the piston 36 by pulling the piston 36 back to the reset position shown in FIG. 2B, which compresses the spring 54 and primes the spring 54 to again drive the piston 36 forward to the position of FIG. 2A when released. It is also to be appreciated that other components, such as a separate pressurization tank, valves, controllers, sensors, etc. may be included to monitor, control, or facilitate the flow of pressurized fluid out of the pressure chamber 38.

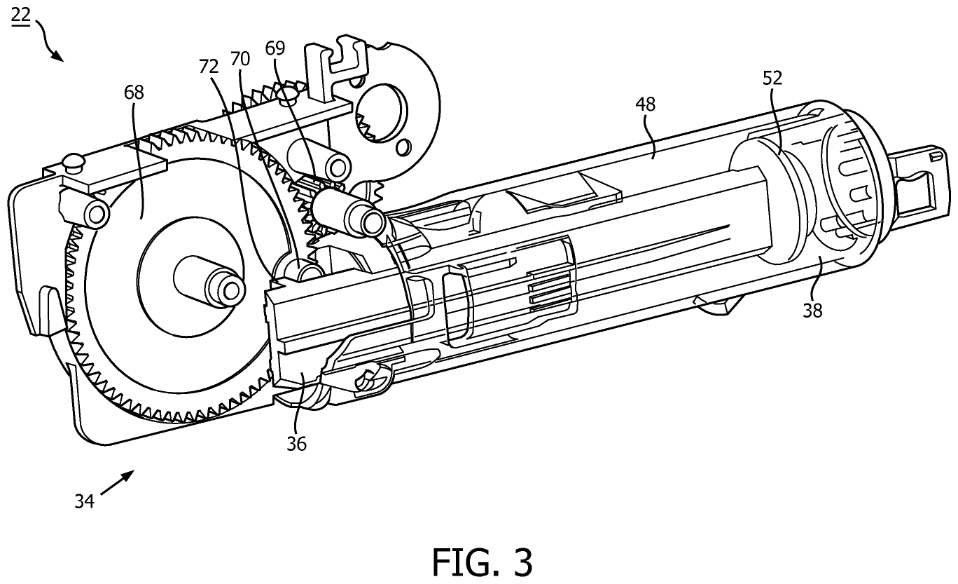

FIGS. 3-6 illustrate a pump assembly 22 according to one embodiment disclosed herein. The pump assembly 22 includes a cylinder 48 within which a piston 36 having a piston head 52 reciprocates. A pressure chamber 3838 is defined within the cylinder 48 on one side of the piston head 52. The pump assembly 22 also includes a drivetrain 34 that is arranged to provide power from a motor 32 to operate the piston 36. 34A spring or other biasing member is not illustrated in the cylinder 48 (for clarity of the other components), however, it is understood that a biasing member, e.g., resembling the spring 54, may be included in the cylinder 48 on the opposite side of the piston head 52 from the pressure chamber 38 and arranged to exert a driving force on the piston 36 via engagement against the piston head 52.

The drivetrain 34 has a drive member 68, which is coupled directly (e.g., located on the output shaft of the motor) or indirectly (e.g., via one or more intermediary gears 69) to the output of a motor 32. In the illustrated embodiment, the drive member 68 is arranged as a gear because it is coupled to the intermediary gear 69, however it is to be understood that in other embodiments, the drive member 68 may take any other form, e.g., a wheel, plate, bar, linkage, etc., or shape, e.g., round, rectangular, triangular, etc. The drive member 68 includes a pin 70 eccentrically positioned with respect to an axis of rotation of the drive member 68 and protruding therefrom in a direction generally toward the piston 36. The piston 36 correspondingly includes a hook 72 extending from the piston 36 in a direction generally toward the drive member 68. The hook 72 and the pin 70 overlap in physical space such that the pin 70 will contact the hook 72 when the drive member 68 rotates the pin 70 into alignment with the hook 72.

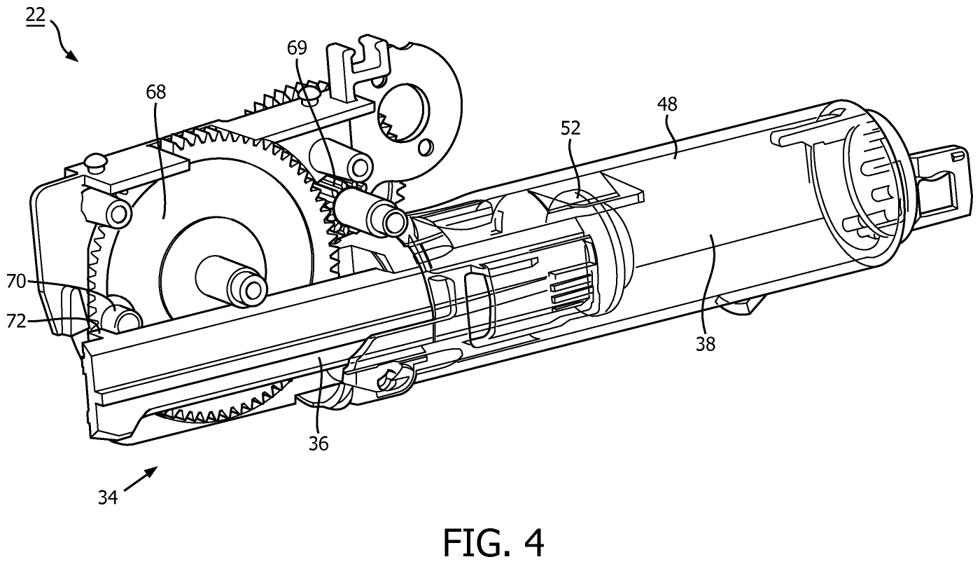

In FIG. 3, the piston 36 is shown in its deployed or forward position (i.e., after being driven by a biasing element such as the spring 54) and the pin 70 is shown in a position at which the pin 70 has just contacted the hook 72 as the drive member 68 rotates the pin 70 clockwise with respect to the orientation of FIG. 3. Due to the eccentric positioning of the pin 70 on the drive member 68, rotation of the drive member 68 causes translation of the pin 70 in both a first component direction corresponding to the direction of reciprocation of the piston 36 as well as at least a second component direction transverse to the direction of reciprocation of the piston 36. In this way, continuing to rotate the drive member 68 (in the clockwise direction with respect to the orientation of FIG. 3) will overcome the spring force of the biasing element in the cylinder 48 (e.g., the spring 54) cause the piston 36 to be pulled in back toward its reset position (shown in FIG. 4) via the engagement between the pin 70 and the hook 72. As noted above with respect to the pump assembly 22, the difference between the position of the piston 36 in FIG. 3 and FIG. 4 defines the stroke length of the piston 36.

Once the drive member 68 and the pin 70 reach the position in FIG. 4, further rotation of the drive member 68 (in the clockwise direction with respect to the orientation of FIG. 4) will cause the pin 70 to disengage from the hook 72 as the pin 70 moves away from the hook 72. After disengagement of the pin 70 from the hook 72, the piston 36 is released so that it can be driven by a biasing member (e.g., the spring 54) back toward its forward or deployed position, thereby pressurizing fluid in the pressure chamber 38. Upon the drive member 68 rotating sufficiently, the pin 70 will return to the position shown in FIG. 3 and the process will repeat, enabling repeated and consistent pressurization of the fluid in the pressure chamber 38. In this way, the drivetrain 34 and/or the pump assembly 22 may be considered a “semi-free” system, in that the piston 36 is not always coupled to or engaged with the drivetrain 34, with the piston 36 free to be driven forward (e.g., via the spring 54 or other biasing element) when decoupled or disengaged from the drivetrain 34.

It is to be appreciated that the pin 70 and the hook 72 are protrusions that can take any shape or form that enables these two components to physically contact and engage together such that force can be transferred by the drive member 68 to the piston 36 through the engagement of the pin 70 and the hook 72. In one embodiment, the pin 70 and/or the hook 72 are integrally formed with the drive member 68 and the piston 36, respectively, while in another embodiment the pin 70 and/or the hook 72 are separate components coupled to their respective components in a suitable manner, e.g., screws, bolts, welds, adhesives, etc.

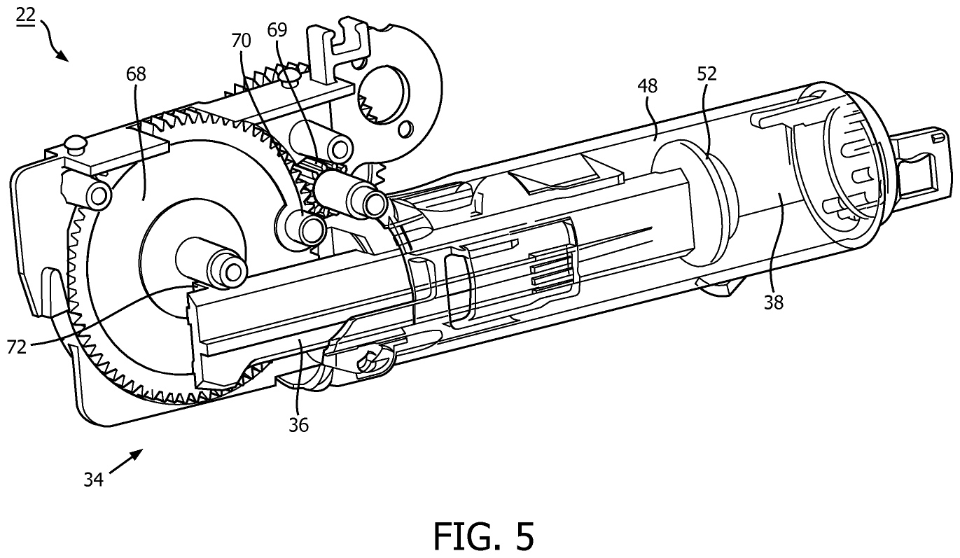

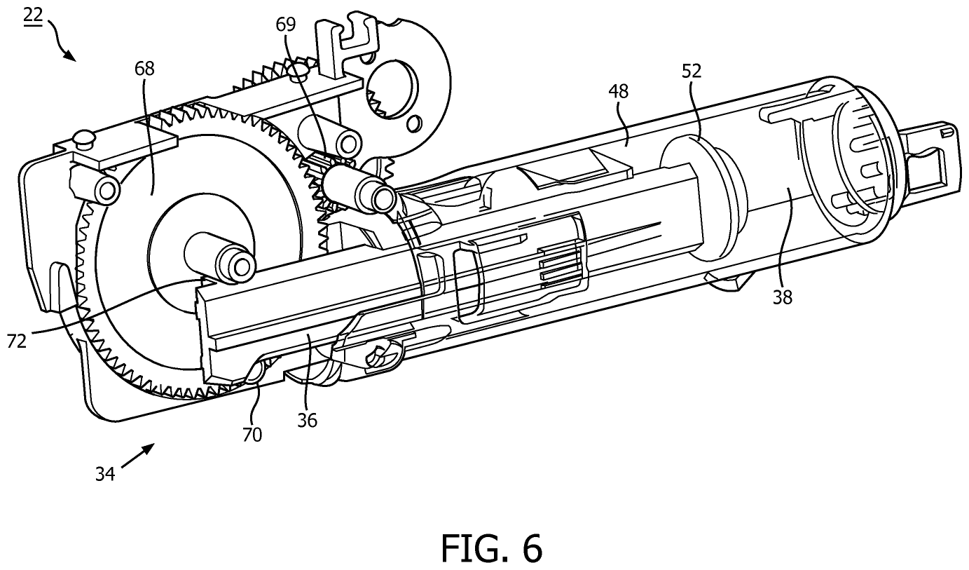

Advantageously, the “semi-free” interaction of the pin 70 and the hook 72 enables the pump assembly 22 to reset the piston 36 back to its reset position regardless of where the piston 36 is located along the length of the cylinder 48. For example, as shown in FIG. 5, the piston 36 is located at a location somewhere between the deployed position of FIG. 3 and the reset position of FIG. 4. For this reason, the pin 70 is not contacting the hook 72 in FIG. 5 despite the pin 70 being located in generally the same location as FIG. 3. Regardless, continued rotation of the drive member 68 will result in the pin 70 eventually encountering and engaging against the hook 72, as shown in FIG. 6. Once the pin 70 and the hook 72 are engaged, the pump assembly 22 operates as described above, i.e., with rotation of the drive member 68 causing the piston 36 to be pulled back to its reset position as shown in FIG. 4 via engagement between the pin 70 and the hook 72.

It is to be appreciated that due to the above-described “semi-free” construction of the drivetrain 34, the pin 70 is able to engage the hook 72 and reset the piston 36 regardless of the piston 36 being positioned at any location along the length of the cylinder 48. In effect, this enables the stroke length of the piston 36 to be variably set. For example, a stroke limiting mechanism, \ 42, can be included to set the stroke length of a piston to be any length shorter than a maximum stroke length for that piston. For example, in one embodiment the position shown in FIG. 4 corresponds to a deployed position for the piston 36 when the piston 36 is permitted to have its maximum (longest) stroke length, while the position of FIG. 5 corresponds to a deployed position for the piston 36 when the stroke length is set (e.g., by a stroke limiting mechanism 42 to be an intermediate stroke length that is shorter than the maximum stroke length.

It is again noted that the stroke length of the piston 36 determines the location of the piston head 52 with respect to the cylinder 48 when the piston 36 is in its deployed position. It is also noted that the volume of the pressure chamber 38 changes with respect to the location of the piston head 52 (i.e., due to the pressure chamber 38 being bounded on one side by the piston head 52 and fixed on all other sides by the cylinder 48). It is additionally noted that the pressure of fluid within the pressure chamber 38 is at least partially a function of the volume of the pressure chamber 38 (i.e., the ideal gas law indicates that pressure of a gas rises as volume decreases). In this manner, changing the stroke length of the piston 36 can be used to change the pressure of fluid in the chamber 38 (e.g., with respect to gas which will compress into smaller volumes) and/or the pressure of the fluid that is communicated out of the chamber 38 (e.g., liquids are generally incompressible, so changing the stroke length will change the total volumetric flow out of the pressure chamber 38, e.g., into a fluid pathway having a relatively restricted cross-sectional flow area, such as the fluid pathway 20). In either case, a higher pressurization of fluid in the pressure chamber 38 is achieved. Longer stroke lengths for the piston 36 will cause the piston head 52 to push deeper into the cylinder 48, which will result in the piston 3836 attempting to reach a position at which the volume of the pressure chamber 38 has been relatively decreased, and therefore the fluid in the pressure chamber has been pressurized to a higher degree.

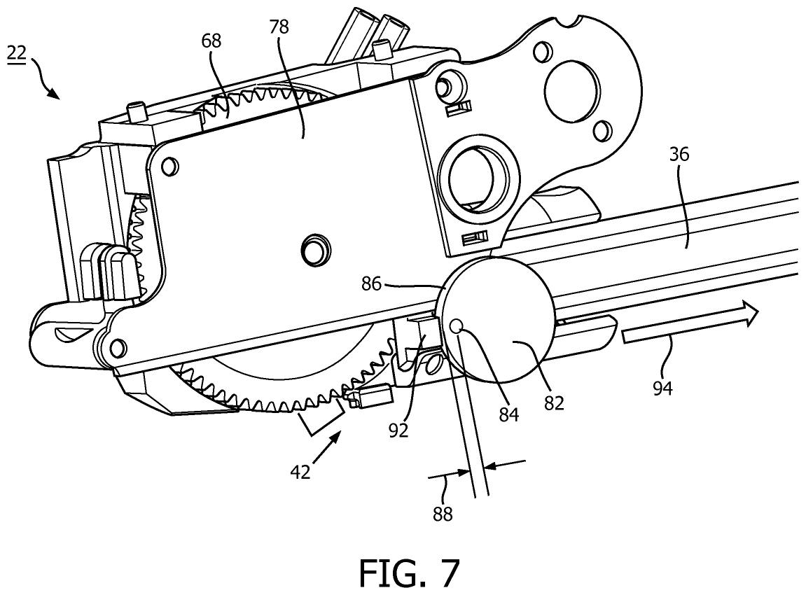

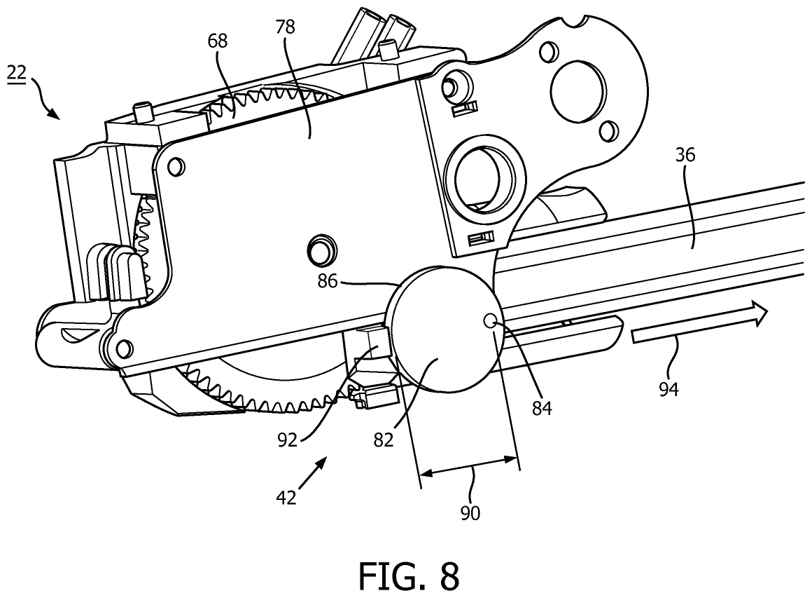

FIGS. 7-8 illustrate a pump assembly 22 having a stroke limiting mechanism 42 according to one embodiment. t Note that pin 70 is hidden from view in FIGS. 7-8 behind a housing plate 78.

The pump assembly 22 includes a piston 36 (shown only in part) that can be arranged generally in accordance with any of the pistons disclosed herein, i.e., reciprocal within a cylinder to pressurize fluid within a pressure chamber when driven forward by a biasing element such as a compression spring, and reset by the pin 70 of the drive member 68 engaging a hook (not shown in FIGS. 7-8, but generally understood to resemble any embodiment of the hook 72 described herein) on the piston 36 to pull the piston 36 back to its reset position.

The stroke limiting mechanism 42 includes a stopping member 82 that is rotatably coupled to the housing plate 78. The stopping member 82 in the illustrated embodiment takes the form of a disc eccentrically mounted to the housing plate 78 at a pivot 84 that is coupled to the housing plate 78. In this way, the distance between the pivot 84 and a stopping surface 86 varies at different points around the circumference of the stopping member, i.e., with a dimension 88 in FIG. 7 designating a minimum distance from the pivot 84 and dimension 90 designating a maximum distance. The pivot 84 can be arranged as any desired rotatable member, e.g., pin, shaft, etc.

As part of the stroke limiting mechanism 42, the piston 36 is arranged with a protrusion 92. The protrusion 92 may take any form or shape extending transversely from the piston 36 generally toward the stopping member 82. The protrusion 92 is arranged to engage against a stopping surface of the stroke limiting mechanism 42 to stop forward motion of the piston 80, which thereby limits the distance that the piston 36 can travel when being driven forward by a biasing member. In other words, such a stopping surface can be used to define the stroke length of the piston 36. By arranging the stopping member 82 to overlap in physical space with the protrusion 92, the protrusion 92 will engage against the stopping surface 86 of the stopping member 82 during the transition of the piston 36 from its reset position to its deployed position (an arrow 94 is provided in FIGS. 7-8 to indicate the pumping direction of the piston 36). In this way, the stopping surface 86 of the stopping member 82 is arranged to act as a stopping surface for the piston 36.

Since the distance between the pivot 84 and the stopping surface 86 is variable depending on the angle of rotation of the stopping member 82, the stroke length of the piston 36 can be set by rotating the stopping member 82 to a desired angle. For example, in FIG. 7, the stopping member 82 is rotated so that the minimum dimension 88 is aligned with the protrusion 92 with respect to the pumping direction 94, while in FIG. 8, the stopping member 82 is rotated so that the maximum dimension 90 is aligned with the protrusion 92 with respect to the pumping direction 94. Since the minimum dimension 88 is less than the maximum dimension 90, the stopping surface 86 is positioned relatively closer to the pressure chamber of the pump assembly 22 (i.e., the stopping surface is further toward the deployed position with respect to the pumping direction 94), and thereby permits a longer stroke, when the minimum dimension 88 is aligned with the protrusion 92 of the piston 36. This can be best appreciated in view of a comparison of FIGS. 7 and 8, in which alignment of the maximum dimension 90 with the protrusion 92 (FIG. 8) limits the distance that the piston 36 can travel relative to when the minimum dimension 88 is aligned with the protrusion 92 (FIG. 7). In other words, the stroke length of the piston 36 is longer when the minimum dimension 88 of the stopping member 82 is aligned with the protrusion 92 as opposed to when the maximum dimension 90 is aligned with the protrusion 92. More specifically, the stroke length is reduced by a length equal to the difference between the maximum dimension 90 and the minimum dimension 88. By rotating the stopping member 82 to angles between the minimum and maximum, other variable stroke lengths can be achieved.

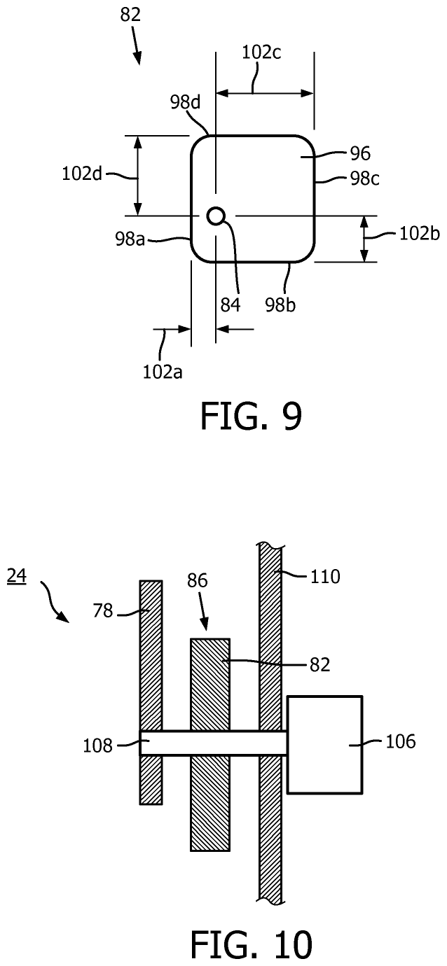

FIG. 9 illustrates another embodiment for a stopping member 82, which is generally square in shape, having a plurality of stopping surfaces 98a, 98b, 98c, and 98d. By rotating the stopping member 82 about a pivot 84, different ones of the surfaces 98a, 98b, 98c, and/or 98d can be aligned with the protrusion (e.g., the protrusion 92) of the corresponding piston having its stroke limited by the stopping member 82. The surfaces 98a-98d corresponding to four different dimensions 102a-102d, respectively, which can be used to set the piston stroke to four different lengths that vary depending on the dimensions 102a-102d. Thus, the stopping surfaces 98a-98d correspond to four different pressurization settings for fluid communicated out of the pressure chamber of the pump assembly that includes the stopping member 82. It is to be appreciated that any other shape having any number of sides corresponding to any number of stopping surfaces may be similarly arranged.

FIG. 10 is a cross-sectional schematic view that illustrates one embodiment of a user input 24 that is in mechanical communication with the stopping member 82. More specifically, in this embodiment, the user input 24 includes a knob 106 that is configured to be physically manipulated by a user. The knob 106 is on the end of a shaft 108, which replaces the pivot 84, and extends from the housing plate 78 through an outer wall 110 of the body 12 of the device 10, to enable a user to manipulate the stopping member 82 from outside of the device 10. The stopping member 82 and the knob 106 are both mounted on the shaft 108 so that rotation of the knob 106 by a user will correspondingly result in rotation of the stopping member 82.

The outer surface of the outer wall 110 could include words, numbers, symbols, etc., corresponding to the position that the knob 106 should be set in order to set the stroke length to yield different pressurizations for the fluid that is discharged via the fluid pathway 20 out of the port of the device 10. In one embodiment, the knob 106 may have words or symbols corresponding to “HIGH” or “LOW” settings for the fluid flow, where the HIGH setting might correspond to the minimum dimension 88 of the stopping member 82 being aligned with the corresponding protrusion (e.g., the protrusion 92) of the piston 36 that is having its stroke length adjusted, since the minimum dimension 88 corresponds to a longer stroke and therefore a higher pressurization of fluid. Similarly, the LOW setting might correspond to the maximum dimension 90 of the stopping member 82 being aligned with the corresponding protrusion (e.g., the protrusion 92) of the piston 36 that is having its stroke length adjusted, since the maximum dimension 90 corresponds to a shorter stroke and therefore a lower pressurization of fluid.

It is to be understood that the knob 106 is just one example of a component for a user input 24. Any other component or assembly that translates user-inputted motion (dial turning, button pressing, toggle sliding, lever flipping, etc.) could be included and translated into appropriate movement to change the location of the corresponding stopping member in the pumping direction, thereby enabling adjustment of the stroke length of the piston.

While several inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

It should also be understood that, unless clearly indicated to the contrary, in any methods claimed herein that include more than one step or act, the order of the steps or acts of the method is not necessarily limited to the order in which the steps or acts of the method are recited.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively.

1. A pump assembly comprising:
a piston configured to reciprocate between a reset position and a deployed position to pressurize a fluid in a pressure chamber;
a biasing member configured to exert a driving force on the piston to drive the piston in a pumping direction from the reset position to the deployed position;
a drivetrain engageable with the piston and providing power sufficient to overcome the driving force of the biasing member and transitioning the piston from the deployed position back to the reset position;
a stroke limiting mechanism having a stopping member with a stopping surface against which a protrusion of the piston contacts to define a stroke length of the piston by limiting movement of the piston in the pumping direction when the protrusion engages the stopping surface;
wherein the stopping member has a first configuration corresponding to a first stroke length for the piston and a second configuration corresponding to a second stroke length for the piston, the first stroke length corresponding to a first pressurization of the fluid and the second stroke length corresponding to a second pressurization of the fluid that is different than the first pressurization, wherein transitioning the stopping member between the first and second configurations positions the stopping surface at different locations relative to the deployed position with respect to the pumping direction;
wherein, the stopping member comprises a disc shape or a generally square shape, wherein the stopping member is rotatably coupled to a housing plate of the pump assembly at a pivot, wherein distances between the pivot and the stopping surface varies around a circumference of the stopping member; and
wherein rotation of the stopping member is configured to transition the stopping member from the first configuration to the second configuration such that the stopping surface is positioned closer to the deployed position, with respect to the pumping direction, when the stopping member is in the first configuration than when the stopping member is in the second configuration, which results in the first stroke length being longer than the second stroke length and the first pressurization being greater than the second pressurization.

2. The pump assembly of claim 1, further comprising a motor, wherein the power provided by the drivetrain to the piston is generated by the motor.

3. The pump assembly of claim 1, wherein the drivetrain is semi-free in that the drivetrain is both engaged and disengaged from the piston at different times during reciprocation of the piston.

4. The pump assembly of claim 1, wherein the drivetrain includes a drive member having a pin eccentrically mounted thereto and extending therefrom, wherein rotation of the drive member brings the pin into engagement with a hook extending from the piston and power from the drivetrain is transferred to the piston via engagement of the pin and the hook.

5. The pump assembly of claim 4, wherein further rotation of the drive member causes the pin to disengage from the hook to decouple the piston from the drivetrain and the biasing member exerts the drive force when the piston is decoupled from the drivetrain.

6. (canceled)

8. (canceled)

9. (canceled)

10. An oral care device including a pump assembly according to claim 1.

11. The oral care device of claim 10, further comprising a fluid pathway in fluid communication with the pressure chamber, the fluid pathway terminating in a port of a nozzle head of the oral care device, wherein the fluid is emitting out of the device via the port.

12. The oral care device of claim 10, further comprising a user input in communication with the stroke limiting mechanism of the pump assembly.

13. The oral care device of claim 12, wherein the user input is mechanically coupled to the stroke limiting mechanism.

14. The oral care device of claim 13, wherein the user input device includes a knob, slider, lever, button, or dial that is configured to translate user inputted manipulation to a corresponding motion of the stopping member of the stroke limiting mechanism.

15. The oral care device of claim 12, further comprising a controller that is arranged in signal communication with both the stroke limiting mechanism and the user input and configured to implement commands inputted via the user input to the stroke limiting mechanism.
